(19) United States
(12) Patent Application Publication
(10) Pub. No.: US 2024/0387118 A1
(43) Pub. Date: Nov. 21, 2024

(54) CIRCUIT BREAKER

(71) Applicant: Siemens Aktiengesellschaft, München (DE)

(72) Inventors: Marvin Tannhäuser, Hausen (DE); Manfred Heindl, Alteglofsheim (DE); Jörg Hussmann, Neumarkt (DE)

(21) Appl. No.: 18/696,492

(22) PCT Filed: Sep. 16, 2022
(86) PCT No.: PCT/EP2022/075760

§ 371 Date: Mar. 28, 2024

(30) Foreign Application Priority Data
Sep. 28, 2021 (DE) 10 2021 210 820.2

(51) Int. Cl. H01H 9/54

(52) U.S. Cl. CPC H01H 9/548

(57) ABSTRACT

A circuit breaker protecting an electrical low-voltage circuit includes a housing with grid-side and load-side connections for the circuit. A mechanical isolating contact unit is series-connected to an electronic interruption unit. The isolating contact unit is paired with the load-side connections. The interruption unit is paired with the grid-side connections. The isolating contact unit is switchable by opening contacts preventing, or by closing contacts allowing, current flow in the low-voltage circuit. Semiconductor-based switch elements of the interruption unit are switchable to high-ohmic state preventing, or to low-ohmic state allowing, current flow in the low-voltage circuit. A current sensor unit ascertains current level of the low-voltage circuit and a control unit is connected to the current sensor unit, isolating contact unit, and interruption unit. Exceeding current and/or current/time thresholds prevents current flow in the low-voltage circuit.

The invention relates to the technical field of a circuit breaker device for a low-voltage circuit having an electronic interruption unit.

Low voltage is understood to mean voltages of up to 1000 volts AC or up to 1500 volts DC. Low voltage is understood in particular to mean voltages that are greater than extra-low voltage, with values of 50 volts AC or 60 volts DC.

A low-voltage circuit or grid or installation is understood to mean circuits with nominal currents or rated currents of up to 125 amperes, more specifically up to 63 amperes. A low-voltage circuit is understood to mean in particular circuits with nominal currents or rated currents of up to 50 amperes, amperes, 32 amperes, 25 amperes, 16 amperes or 10 amperes. Said current values are understood to mean in particular nominal, rated or/and shutdown currents, that is to say the maximum current that is normally carried through the circuit or in the case of which the electrical circuit is usually interrupted, for example by a protection device, such as a circuit breaker device, miniature circuit breaker or power circuit breaker. The nominal currents may be gradated further, from 0.5 A through 1 A, 2 A, 3 A, 4 A, 5 A, 6 A, 7 A, 8 A, 9 A, 10 A, etc. up to 16 A.

Miniature circuit breakers are overcurrent protection devices that have long been known and that are used in low-voltage circuits in electrical installation engineering. They protect lines against damage caused by heating due to excessively high current and/or a short circuit. A miniature circuit breaker may automatically shut down the circuit in the event of an overload and/or short circuit. A miniature circuit breaker is not a fuse element that resets automatically.

In contrast to miniature circuit breakers, power circuit breakers are intended for currents greater than 125 A, in some cases also starting from 63 amperes. Miniature circuit breakers therefore have a simpler and more delicate design. Miniature circuit breakers usually have a fastening option for fastening to a so-called top-hat rail (carrier rail, DIN rail, TH35).

Miniature circuit breakers have an electromechanical design. In a housing, they have a mechanical switching contact or operating current tripping device for interrupting (tripping) the electric current. A bimetal protection element or bimetal element is usually used for tripping (interruption) in the event of a sustained overcurrent (overcurrent protection), respectively in the event of a thermal overload (overload protection). An electromagnetic tripping device with a coil is used for brief tripping in the event of an overcurrent limit value being exceeded or in the event of a short circuit (short circuit protection). One or more arc extinguishing chambers or arc extinguishing devices are provided. Connection elements for conductors of the electrical circuit to be protected are also provided.

Circuit breaker devices having an electronic interruption unit are relatively recent developments. They have a semiconductor-based electronic interruption unit. In other words, the electric current flow in the low-voltage circuit is guided via semiconductor components or semiconductor switches that are able to interrupt the electric current flow or are able to be switched to the on state. Circuit breaker devices having an electronic interruption unit often also have a mechanical isolating contact system, in particular with isolator properties in accordance with the applicable standards for low-voltage circuits, wherein the contacts of the mechanical isolating contact t system are connected in series with the electronic interruption unit, that is to say the current of the low-voltage circuit to be protected is guided both through the mechanical isolating contact system and through the electronic interruption unit.

The object of the present invention is to improve a circuit breaker device of the type mentioned at the outset, in particular to specify a novel, simple and improved architecture for such a circuit breaker device.

This object is achieved by a circuit breaker device having the features of patent claim 1.

According to the invention, what is proposed is a circuit breaker device for protecting an electrical low-voltage circuit, in particular low-voltage AC circuit, having:
a housing having grid-side connections and load-side connections for the low-voltage circuit,
an in particular two-pole mechanical isolating contact unit that is connected in series with an in particular single-pole electronic interruption unit, wherein the mechanical isolating contact unit is assigned to the load-side connections and the electronic interruption unit is assigned to the grid-side connections,
wherein the mechanical isolating contact unit is able to be switched by opening contacts so as to avoid a current flow or closing the contacts to allow a current flow in the low-voltage circuit,
wherein the electronic interruption unit is able to be switched by semiconductor-based switching elements to a high-resistance state of the switching elements so as to avoid a current flow or a low-resistance state of the switching elements so as to allow a current flow in the low-voltage circuit,
a current sensor unit for ascertaining the level of the current of the low-voltage circuit,
a control unit that is connected to the current sensor unit, the mechanical isolating contact unit and the electronic interruption unit, wherein, in the event of current or/and current-time limit values being exceeded, avoidance of a current flow in the low-voltage circuit is initiated.

According to the invention, what is proposed in particular is a two-pole circuit breaker device, wherein the electronic interruption unit is assigned to the grid-side connections, that is to say is normally supplied constantly with power/is live, and the mechanical isolating contact unit is assigned to the load-side connections, that is to say only interrupts the current flow to a load, wherein the circuit breaker device continues to be supplied with power.

This has the advantage that the circuit breaker device is ready for use immediately and is also able to take on communication functions and other functions after a load has been deactivated.

Advantageous embodiments of the invention are specified in the dependent claims and in the exemplary embodiment.

In one advantageous embodiment of the invention, provision is made for a power supply unit that is connected, or is able to be connected, to the grid-side connections. The power supply unit is connected to the control unit in order to provide a power supply.

This has the particular advantage that the circuit breaker device is normally supplied constantly with power, so as to enable constant operation under normal circumstances.

In one advantageous embodiment of the invention, the connection between the power supply unit and the grid-side connections has a fuse or/and a switch.

This has the particular advantage that the power supply unit or the control unit is able to be deactivated, for example for insulation measurements. The power supply unit or the control unit may also be safeguarded in order to achieve increased protection for the circuit breaker device against further faults.

In one advantageous embodiment of the invention, the grid-side connections comprise a grid-side neutral conductor connection and a grid-side phase conductor connection. The load-side connections comprise a load-side neutral conductor connection and a load-side phase conductor connection.

This has the particular advantage of providing a two-pole implementation or two-pole galvanic isolation.

In one advantageous embodiment of the invention, the load-side neutral conductor connection and the load-side phase conductor connection are connected to the mechanical isolating contact unit. In one advantageous embodiment of the invention, the electronic interruption unit is connected to the grid-side phase conductor connection.

This has the particular advantage of providing a circuit breaker device with a mechanical two-pole galvanically isolating and electronic single-pole protective action, wherein the electronic interruption unit is advantageously arranged in the current path of the phase conductor or phase conductor (current) path (and wherein the level of the current is advantageously also ascertained here). This reduces outlay and provides a circuit breaker device that provides reliable interruption, is state-of-the-art and nevertheless has a simple architecture.

In one advantageous embodiment of the invention, the load-side neutral conductor connection and the load-side phase conductor connection are connected, in particular exclusively, to the mechanical isolating contact unit, such that, when the contacts of the mechanical isolating contact unit are opened, the load-side connections are galvanically isolated from the other live units of the circuit breaker device and the grid-side connections.

This has the particular advantage of providing reliable electrical galvanic isolation from all other units or components of the circuit breaker device that may be live, in particular at a voltage greater than (protective) extra-low voltage. This makes it possible to ensure that the load-side connections are guaranteed to be voltage-free when the contacts are opened. On account of this novel architecture, an electronic circuit breaker device thus provides an increased level of safety, with which an increased level of safety is provided in the low-voltage circuit. At least the same level of safety as in conventional circuit breaker devices is achieved.

In one advantageous embodiment of the invention, the mechanical isolating contact unit has a handle for manually opening and closing the contacts.

The handle in particular indicates a position of the contacts. Normally, the position of the handle matches the position of the contacts. Exceptions here would be for example stuck contacts or the handle being blocked during an opening procedure of the contacts (trip-free mechanism) in which the opening procedure of the contacts is primary and takes precedence over the manual closing procedure using the handle.

This has the particular advantage of providing a circuit breaker device in accordance with conventional miniature circuit breakers.

In one advantageous embodiment of the invention, the mechanical isolating contact unit is designed such that the contacts are able to be opened, but not closed, by the control unit. The contacts of the mechanical isolating contact unit may also be opened in the event of a blocked handle (this is also referred to as a so-called trip-free mechanism).

This has the particular advantage of achieving increased operational safety since the contacts are not able to be closed accidentally by the control unit, and also in particular are not able to be blocked, such that deactivation is achieved in a reliable manner.

In one advantageous embodiment of the invention, the mechanical isolating contact unit is designed such that it is possible to close the contacts using the handle only when an enable signal is present (in particular from the control unit).

This has the particular advantage of achieving increased operational safety in the circuit or the circuit breaker device, since only a functional circuit breaker device enables (manual) closure of the contact.

In one advantageous embodiment of the invention, the mechanical isolating contact unit is designed such that position information about the closed or open state of the contacts is available. Provision may be made in particular for a position sensor. The position information is in particular acquired by the control unit. This has the particular advantage that the control unit is able to acquire the switching state of the mechanical isolating contact unit.

In one advantageous embodiment of the invention, the mechanical isolating contact unit is designed such that provision is made for a mechanical display of the position of the contacts (open or closed), in particular such that said display is independent of the supply voltage.

This has the particular advantage of providing a contact position display that is independent of the supply voltage.

In one advantageous embodiment of the invention, the mechanical isolating contact unit is designed such that multiple contacts of the mechanical isolating contact unit are coupled (mechanically) to one another.

This has the particular advantage of possibly avoiding any voltage transfer.

In one advantageous embodiment of the invention, the circuit breaker device is designed such that the connection between the power supply unit and the grid-side connections has a smaller line cross section or a lower current carrying capacity than the conductors or main current path for the low-voltage circuit through the circuit breaker device (in the housing).

This has the particular advantage, due to the lower current carrying capacity, of improving protection against a short circuit possibly occurring inside the electronic part or electronic units, for example on the side of the power supply unit or the control unit, wherein the short-circuit current or overcurrent has to flow via this connection with a lower current carrying capacity (to the power supply unit).

In one advantageous embodiment of the invention, the electronic interruption unit is a single-pole electronic interruption unit that is provided in particular in the phase conductor current path.

This has the particular advantage that, due to the single-pole nature, outlay is reduced and at the same time, in the case of arrangement in the phase conductor current path, monitoring for overcurrents, short-circuit currents and also for fault-to-ground currents in the low-voltage circuit is enabled.

In one advantageous embodiment of the invention, provision is made for a first voltage sensor unit for ascertaining the level of the voltage across the connections of the electronic interruption unit (EU) of a current path.

This has the particular advantage that ascertaining the functional capability, in particular switching capability, of the electronic interruption unit is advantageously able to be assisted easily by way of ascertaining the level of the voltage across the electronic interruption unit. This thus achieves increased operational safety of a circuit breaker device, since a defective electronic interruption unit is able to be identified easily, and the circuit breaker device is able to be interrupted if necessary.

In one advantageous embodiment of the invention, provision is made for a second voltage sensor unit for ascertaining the level of the voltage at the grid-side connections, in particular between grid-side neutral conductor connection and grid-side phase conductor connection.

This has the particular advantage that the voltage of the grid-side connection is able to be monitored and possibly disconnected in the event of overvoltages or undervoltages in the circuit. The architecture according to the invention thus supports increased operational safety of the circuit breaker device or in the circuit. The switching time of the electronic interruption unit may furthermore be dependent on the measured instantaneous value or phase angle of the voltage at the grid-side connections.

In one advantageous embodiment of the invention, provision is made for a display unit connected to the control unit.

This has the particular advantage of enabling a display of status information in relation to the circuit breaker device. The switching state (high-resistance, low-resistance) of the electronic interruption unit is in particular displayed.

In one advantageous embodiment of the invention, provision is made for a communication unit connected to the control unit.

This has the particular advantage of enabling communication of status information to other circuit breaker devices or a superordinate management system.

In one advantageous embodiment of the invention, provision is made for a temperature sensor unit, in particular for ascertaining the temperature of the electronic interruption unit. The temperature sensor unit may be connected to the electronic interruption unit or/and control unit.

This has the particular advantage of providing further protection against overheating and resultant burn-through of the semiconductor-based switching elements of the electronic interruption unit. This also makes it possible to achieve an increased current carrying capacity.

In the event of at least one temperature limit value being exceeded, the current path/phase conductor path may be interrupted.

In one advantageous embodiment of the invention, provision is made for a differential current sensor connected to the control unit, which differential current sensor acquires a differential current in the two conductors (phase conductor and neutral conductor) in the low-voltage circuit.

This has the particular advantage that the circuit breaker device also has fault current monitoring (differential current monitoring), and thus has a further functionality.

In one advantageous embodiment of the invention, the current sensor unit is provided on the current path side between grid-side phase conductor connection and load-side phase conductor connection.

This has the particular advantage that, due to the arrangement in the phase conductor current path, monitoring for overcurrents, short-circuit currents and also for fault-to-ground currents in the low-voltage circuit is enabled.

In one advantageous embodiment of the invention, the circuit breaker device is designed such that the circuit breaker device is formed essentially at least in two parts inside the housing.

In one advantageous embodiment of the invention, the circuit breaker device has an electronic first part, which has in particular at least one circuit board, specifically one or two circuit boards, on which in particular the control unit, the second voltage sensor unit, the current sensor unit, the power supply unit, the electronic interruption unit, the temperature sensor unit and possibly the first voltage sensor unit or/and the measurement impedance are provided.

In one advantageous embodiment of the invention with two circuit boards, a first circuit board has a high current carrying capacity that is governed by the level of the current of the low-voltage circuit, and which specifically carries the phase conductor current or via which the phase conductor current is guided. This first circuit board has in particular the electronic interruption unit and the current sensor unit, and possibly the first or/and second voltage sensor unit.

The second circuit board has in particular the control unit, in particular a microcontroller, and normally has a lower current carrying capacity. The communication unit or/and display unit may also be provided thereon.

In one advantageous embodiment of the invention, the electronic first part has only three electrically conductive connections for the low-voltage circuit.

This has the particular advantage that different circuit board technologies, such as flex circuit boards, thick copper circuit boards, standard microcontroller circuit boards, circuit boards with a higher or lower proportion of copper or with multiple internal layers, etc., are able to be used in a targeted manner in order to make the design simpler and more flexible and to reduce production costs.

In one advantageous embodiment of the invention, the low-voltage circuit is a three-phase AC circuit and the circuit breaker device has further grid-side and load-side phase conductor connections, between each of which provision is made for a series connection of an electronic interruption unit and a contact of the mechanical isolating contact unit. Further units, such as in particular current sensor units, first or/and second voltage sensor units may be provided in a similar manner. This has the particular advantage of providing a solution for three-phase AC circuits.

In one advantageous embodiment of the invention:
when the contacts of the mechanical isolating contact unit are closed and the interruption unit is in the low-resistance state and
in the event of an ascertained current that exceeds a first current value, in particular when the first current value is exceeded for a first time limit, the electronic interruption unit changes to the high-resistance state and the mechanical isolating contact unit remains closed,
in the event of an ascertained current that exceeds a second current limit value for a second time limit, the electronic interruption unit changes to the high-resistance state and the mechanical isolating contact unit is opened,
in the event of an ascertained current that exceeds a third current value, the electronic interruption unit changes to the high-resistance state and the mechanical isolating contact unit is opened.

This has the particular advantage of providing a stepped deactivation concept for the circuit breaker device according to the invention.

In one advantageous embodiment of the invention, the control unit has a microcontroller.

This has the particular advantage that the functions according to the invention for increasing the safety of a circuit breaker device or of the electrical low-voltage circuit to be protected are able to be implemented by an (adaptable) computer program product. Changes and improvements to the functions may thereby also be loaded individually onto a circuit breaker device.

All embodiments, both in dependent form referring back to patent claim 1 and referring back only to individual features or combinations of features of patent claims, bring about an improvement in a circuit breaker device, in particular a novel architecture and improvement in the safety of a circuit breaker device or of the electrical circuit, and provide a novel concept for a circuit breaker device.

The described properties, features and advantages of this invention and the way in which these are achieved will become clearer and more clearly comprehensible in connection with the following description of the exemplary embodiments, which are explained in more detail in connection with the figures.

In this case, in the drawing:

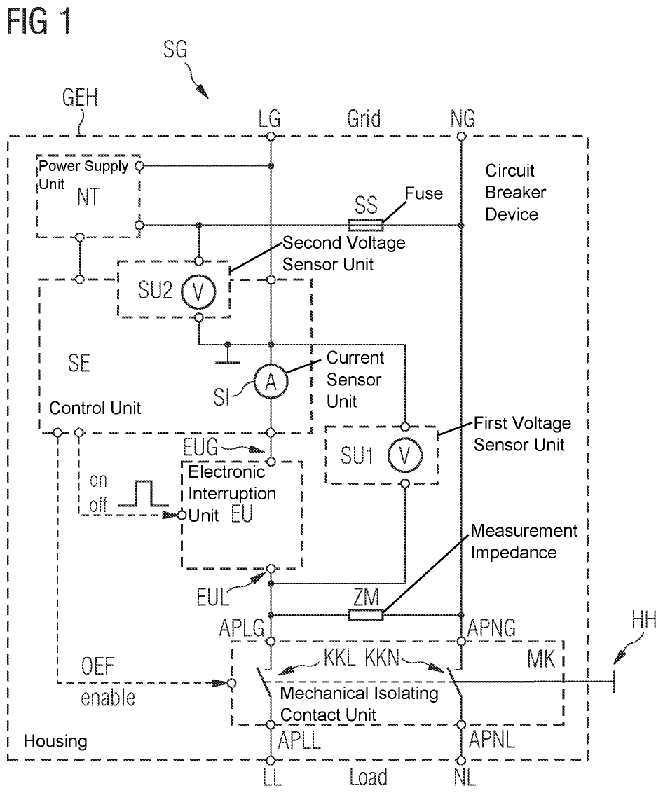

FIG. 1 shows a first basic illustration of a circuit breaker device,

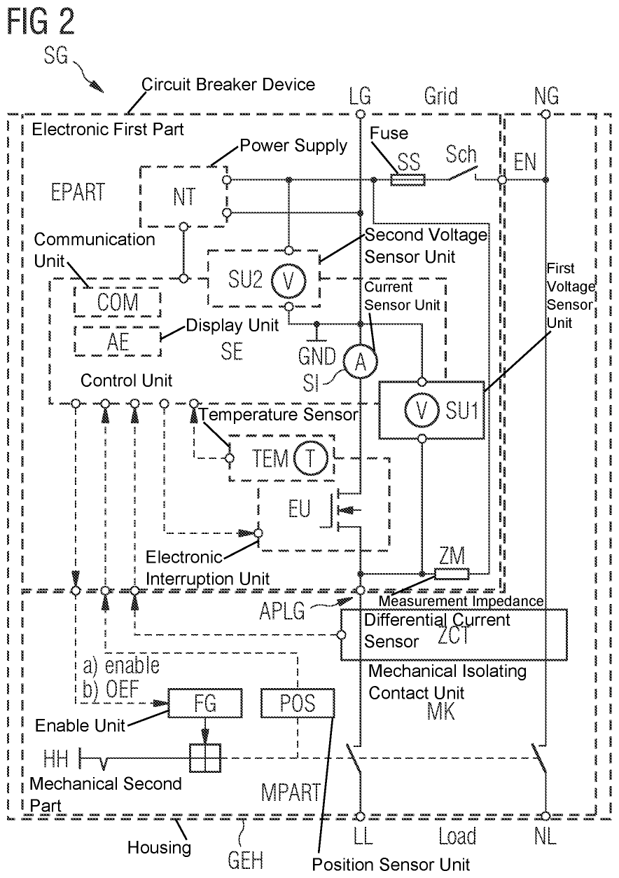

FIG. 2 shows a second basic illustration of a circuit breaker device.

FIG. 1 shows an illustration of a circuit breaker device SG for protecting an electrical low-voltage circuit, in particular low-voltage AC circuit, having a housing GEH, having:
grid-side connections, which in particular comprise a grid-side neutral conductor connection NG and a grid-side phase conductor connection LG,
load-side connections, which in particular comprise a load-side neutral conductor connection NL and a load-side phase conductor connection LL,
the connections are provided for the low-voltage circuit;
a power source is usually connected to the grid-side connections/the grid side GRID;
a consumer is usually connected to the load-side connections/the load side LOAD;
a (two-pole) mechanical isolating contact unit MK having load-side connection points APLL, APNL and grid-side connection points APLG, APNG,
wherein a load-side connection point APNL is provided for the neutral conductor, a load-side connection point APLL is provided for the phase conductor, a grid-side connection point APNG is provided for the neutral conductor and a grid-side connection point APLG is provided for the phase conductor. The load-side connection points APNL, APLL are connected to the load-side neutral and phase conductor connections NL, LL, such that it is possible to switch between opening contacts KKN, KKL so as to avoid a current flow or closing the contacts to allow a current flow in the low-voltage circuit,
an in particular single-pole electronic interruption unit EU (which is arranged in particular in the phase conductor in the case of a single-pole design),
having a grid-side connection point EUG that is electrically connected to the grid-side phase conductor connection LG, and
a load-side connection point EUL that is electrically connected to the grid-side connection point APLG of the mechanical isolating contact unit MK, wherein the electronic interruption unit EU, by way of semiconductor-based switching elements (not illustrated), has or is able to be switched between a high-resistance state of the switching elements so as to avoid a current flow or a low-resistance state of the switching elements so as to allow a current flow in the low-voltage circuit,
a current sensor unit SI for ascertaining the level of the current of the low-voltage circuit, which is arranged in particular in the current path of the phase conductor or phase conductor current path,
a control unit SE that is connected to the current sensor unit SI, the mechanical isolating contact unit MK and the electronic interruption unit EU, wherein, in the event of current or/and current-time limit values being exceeded, avoidance of a current flow in the low-voltage circuit is initiated.

The mechanical isolating contact unit MK, according to the invention, is arranged on the load side, and the electronic interruption unit EU, according to the invention, is arranged on the grid side. The grid side GRID with the power source is normally live. An electrical consumer is normally connected on the load side LOAD.

This has the advantage that there cannot be any further (in particular live) parts or components between the contacts of the mechanical isolating contact unit/load-side connection points (APLL, APNL) of the mechanical isolating contact unit and the two load-side connections (LL, NL). It is thus possible to ensure, owing to this architecture or design, that there is never a voltage at the load-side connections LL, NL when the contacts KKL, KKN are open. This increases the safety of the breaker device.

In contrast thereto, in other architectures in which the mechanical isolating contact unit is arranged on the grid side, there are often electronic units upstream of the load-side connection.

According to the invention, the circuit breaker device may be designed such that the level of the voltage across the electronic interruption unit is advantageously able to be ascertained. In other words, the level of a first voltage between grid-side connection point EUG and load-side connection point EUL of the electronic interruption unit EU is able to be ascertained or is ascertained.

For this purpose, in the example according to FIG. 1, provision is made for a first voltage sensor unit SU1 that is connected to the control unit SE and that ascertains the level of the voltage between grid-side connection point EUG and load-side connection point EUL of the electronic interruption unit EU.

In the voltage measurement performed by the first voltage sensor unit SU1, the voltage across the series connection of electronic interruption unit EU and current sensor SI may alternatively also be ascertained, as illustrated in FIG. 1. The current sensor unit SI has a very low internal resistance, meaning that the ascertaining of the level of the voltage is not impaired, or is impaired to a negligible extent.

Advantageously, provision may be made for a second voltage sensor unit SU2 that ascertains the level of the voltage between grid-side neutral conductor connection NG and grid-side phase conductor connection LG.

The first voltage sensor unit may also be replaced by using two voltage measurements (upstream of the electronic interruption unit and downstream of the electronic interruption unit). Calculating a difference ascertains the voltage across the electronic interruption unit.

Provision may thus be made for a/the second voltage sensor unit SU2 that is connected to the control unit SE and that ascertains the level of a second voltage between grid-side neutral conductor connection NG and grid-side phase conductor connection LG. Provision may also be made for a third voltage sensor unit SU3 (not illustrated) that is connected to the control unit and that ascertains the level of a third voltage between grid-side neutral conductor connection NG and load-side connection point EUL of the electronic interruption unit EU. The circuit breaker device is designed such that the level of a/the first voltage between grid-side connection point EUG and load-side connection point EUL of the electronic interruption unit EU is ascertained from the difference between second and third voltage.

A measurement impedance ZM may be connected between the grid-side connection points APLG, APNG of the mechanical isolating contact unit MK. The measurement impedance ZM may be for example an electrical resistor or/and capacitor. The measurement impedance may furthermore be an inductor. The measurement impedance may in particular be a series connection or parallel connection of a resistor or/and capacitor or/and inductor.

In the example according to FIG. 1, the electronic interruption unit EU has a single-pole design, in the example in the phase conductor. In this case, the grid-side connection point APNG for the neutral conductor of the mechanical isolating contact unit MK is connected to the grid-side neutral conductor connection NG of the housing GEH.

The circuit breaker device SG is advantageously designed such that the contacts of the mechanical isolating contact unit MK are able to be opened, but not closed, by the control unit SE, which is indicated by an arrow from the control unit SE to the mechanical isolating contact unit MK.

The mechanical isolating contact unit MK is able to be operated by a mechanical handle HH on the circuit breaker device SG in order to switch between manual opening or closing of the contacts KKL, KKN. The mechanical handle HH indicates the switching state (open or closed) of the contacts of the mechanical isolating contact unit MK on the circuit breaker 14 device. The contact position (or the position of the handle, closed or open) may also be able to be transmitted to the 16 control unit SE. The contact position (or the position of the handle) may be ascertained for example by way of a sensor, such as a position sensor. The contact position or the 19 switching state may be transmitted to the control unit SE. The position sensor may be part of the mechanical isolating contact unit MK. As an alternative, the position sensor May be a component in the electronic first part (EPART, FIG. 2). By way of example, a Hall sensor may be provided in the electronic first part (EPART) and acquire and transmit the position of the contacts or/and of the handle in contactless fashion.

The mechanical isolating contact unit MK is advantageously designed such that it is possible to (manually) close the contacts using the mechanical handle only after an enable, in particular an enable signal. This is likewise indicated by the arrow from the control unit SE to the mechanical isolating contact unit MK. In other words, the contacts KKL, KKN of the mechanical isolating contact unit MK are able to be closed by the handle HH only when the enable or the enable signal (from the control unit) is present. Without the enable or the enable signal, although the handle HH is able to be actuated, the contacts are not closed (“permanent slider contacts”).

The circuit breaker device SG has a power supply or power supply unit NT, for example a switched-mode power supply unit.

The power supply/power supply unit NT is provided in particular for the control unit SE, which is indicated by a connection between power supply/power supply unit NT and control unit SE in FIG. 1. The power supply/power supply unit NT is connected (on the other side) to the grid-side neutral conductor connection NG and the grid-side phase conductor connection LG. Provision may advantageously be made for a fuse SS, in particular thermal fuse, or a switch SCH (FIG. 2) in the connection to the grid-side neutral conductor connection NG (or/and phase conductor connection LG).

The power supply unit NT is normally constantly supplied with power according to the invention. It is optionally protected by the fuse SS or is able to be deactivated by the switch SCH. Advantageously, the switch SCH/Sch may be designed such that the switch is only able to be opened when the contacts are in the open state. This increases the safety of the device, since the electronics (in particular the control unit) are not able to be deactivated when the contacts are closed.

The fuse SS not only has the purpose of safeguarding the power supply by way of the power supply unit NT, but is also intended, in particular in the case of a two-part design (see FIG. 2), to protect the “electronic” first part EPART or in particular all of the units thereof (such as specifically control unit, electronic interruption unit, one or more voltage sensors, current sensor, possibly measurement impedance, etc.).

As an alternative, the measurement impedance ZM may be connected to the grid-side neutral conductor connection NG by way of the fuse SS. This advantageously makes it possible to implement a three-pole electronic unit or an electronic first part EPART (FIG. 2), for example in the form of a module that has three connections with regard to the low-voltage circuit, one neutral conductor connection and two phase conductor connections. The electronic first part EPART may have further connections, in particular for control or measurement information, such as for an enable signal Enable/enable, opening signal OEF, position information (from the position unit POS) or/and differential current signal from the differential current sensor ZCT.

The electronics unit or electronic first part EPART (FIG. 2) has for example the electronic interruption unit EU, the control unit SE, the power supply NT (in particular including fuse SS), the current sensor unit SI, optionally the first voltage sensor unit SUL or/and optionally the second voltage sensor unit SU2.

Regarding the three connections with regard to the low-voltage circuit of the electronic first part EPART, there is thus the advantage that only two phase conductor connections have to have a high current carrying capacity (several amperes in order to carry the load current) and the neutral conductor connection only has to have a (comparatively) low current carrying capacity (for example less than 1 A, a few mA-depending on the power demand of the control unit). This simplifies design and increases the safety of the device since, in the event of a fault in the electronic first part EPART, no large short-circuit current is able to flow via this connection.

The low-voltage circuit may be a three-phase AC circuit, with one neutral conductor and three phase conductors. The circuit breaker device may for this purpose be designed as a three-phase variant and for example have further grid-side and load-side phase conductor connections. Electronic interruption units according to the invention and contacts of the mechanical isolating contact unit are similarly each provided between the further grid-side and load-side phase 8 conductor connections, as are current sensor units. Provision may also be made to ascertain voltages (for example using first voltage sensor units).

A high-resistance state is understood to mean a state in which only a current of negligible magnitude flows. High-resistance resistance values are in particular understood to mean those greater than 1 kiloohm, better still greater than 10 kiloohms, 100 kiloohms, 1 megaohm, 10 megaohms, 100 megaohms, 1 gigaohm or more.

A low-resistance state is understood to mean a state in which the current value indicated on the circuit breaker device could flow. Low-resistance resistance values are in particular understood to mean those less than 10 ohms, better still less than 1 ohm, 100 milliohms, 10 milliohms, 1 milliohm or less.

FIG. 2 shows an illustration according to FIG. 1 with the difference that the circuit breaker device is of two-part design. It contains an electronic first part EPART, for example on a circuit board/printed circuit board.

The first part EPART may have the control unit SE, the first voltage sensor unit SU1, the second voltage sensor unit SU2, the current sensor unit SI, the electronic interruption unit EU and the power supply NT. The first part may also have the thermal fuse SS, a switch SCH, the measurement impedance ZM, a temperature sensor TEM (in particular for the electronic interruption unit EU), a communication unit COM, a display unit AE, and, as a variant, a position sensor unit POS.

The electronic first part EPART has only three connections to the low-voltage circuit:
the grid-side phase conductor connection LG as first connection,
a (second) connection for the or to the grid-side phase conductor connection point APLG of the mechanical isolating contact unit MK,
a third connection EN for a connection to the grid-side neutral conductor connection NG.

The two connections: to the grid-side phase conductor connection LG and for the or to the grid-side phase conductor connection point APLG, have a high current carrying capacity, for example several amperes, greater than 10 A/16 A-depending on the nominal current or rated current of the low-voltage circuit, in particular in order to carry the load current even in the event of a short circuit or overload.

The third connection EN for the connection to the grid-side neutral conductor connection NG has a (comparatively) low current carrying capacity, for example less than 1 A, a few mA-depending on the power demand of the units supplied, specifically in the electronic first part EPART. The third connection EN is designed with a lower current carrying capacity in order to supply the power supply unit with current and in order to allow a voltage measurement between the phase conductor and the neutral conductor of the low-voltage circuit. This third connection EN is in particular protected by a fuse SS. This may be implemented by a thermal fuse or an inexpensive conductor track fuse (thin conductor track with corresponding length and thickness on the circuit board). This has the particular advantage that, due to the lower current carrying capacity in this line or on this third connection EN, protection against a short circuit occurring within the electronic first part (EPART) (or (electronic) units), for example on the side of the power supply unit or the control unit, is improved.

In other words, in the event of dropout or failure of an electronic component of a unit within the electronic first part EPART, no hazardous short-circuit current (fed from the grid-side connections LG, NG), which could cause a fire in the device, is able to arise.

This short-circuit current is fed from the grid via the grid-side connections. An upstream circuit breaker often has a much higher trip current and feeds low-voltage circuits that are provided in parallel. In the event of a fault in the circuit breaker device (the circuit breaker device of the protected low-voltage circuit) and tripping of the upstream circuit breaker, fault-free parallel circuits would thus also be deactivated, which is thus avoided.

The communication unit COM may in particular be a wireless communication unit.

The circuit breaker device contains an in particular mechanical second part MPART. The second part MPART may have the mechanical isolating contact unit MK, the handle HH, and an enable unit FG. The second part may also have a position unit POS for reporting the position of the contacts of the mechanical isolating contact unit MK to the control unit, and the (one or more neutral conductor) connections. Provision may also be made for a differential current sensor ZCT, such as a summing converter, as known for example from conventional fault current circuit breakers.

Provision may be made for further units that are not shown in more detail.

This division into two parts advantageously makes it possible to achieve a compact circuit breaker device according to the invention with a simplified design.

The enable unit/enable function FG enables the actuation of the contacts of the mechanical isolating contact unit by way of the handle HH when an enable signal enable is present. In other words, it is possible to close the contacts KKL, KKN using the handle only when the enable signal enable (from the control unit SE) is present. Otherwise, closing is not possible (handle HH permanently slides). The contacts remain in the open position/switching state. The enable unit FG May also open the contacts (second function of the enable unit FG) when an opening signal OEF (from the control unit SE) is present. The enable unit/enable function FG then acts as a trip unit for opening the contacts of the mechanical isolating contact unit MK.

The current path through the series-connected mechanical isolating contact unit MK and the single-pole electronic interruption unit EU, in the case of arrangement in the phase conductor according to FIG. 1, forms a phase conductor path, that is to say a path for the phase conductor through the circuit breaker device SG (inside the housing). The neutral conductor is then guided only through the mechanical isolating contact unit MK, and is then a neutral conductor path, that is to say a path for the neutral conductor through the circuit breaker device SG (inside the housing).

If a fault occurs in the existing electronics (control unit or/and an electronic interruption unit), the circuit breaker device identifies the fault and puts the device into a safe state.
a) The fault in the electronics is detected.
b) The device switches the power semiconductor off (high-resistance state).
c) The device opens the mechanical isolating contact. The switching lock is in an off state and it is not possible to perform switch-on through mechanical actuation/using the handle.
d) The fault is reported via the communication unit COM.

The invention proposes a novel expedient arrangement of all required components for a circuit breaker device.

Although the invention has been described and illustrated in more detail by the exemplary embodiment, the invention is not restricted by the disclosed examples and other variations May be derived therefrom by a person skilled in the art without departing from the scope of the invention.

1-23. (canceled)

24. A circuit breaker device for protecting an electrical low-voltage circuit, the circuit breaker device comprising:
a housing having grid-side connections and load-side connections for the low-voltage circuit;
an electronic interruption unit associated with said grid-side connections, said electronic interruption unit having semiconductor-based switching elements;
a mechanical isolating contact unit connected in series with said electronic interruption unit, said mechanical isolating contact unit being associated with said load-side connections, and said mechanical isolating contact unit having contacts;
said mechanical isolating contact unit configured to be switched by opening said contacts to avoid a current flow or closing said contacts to allow a current flow in the low-voltage circuit;
said electronic interruption unit configured to be switched by said semiconductor-based switching elements to a high-resistance state of said semiconductor-based switching elements to avoid a current flow or a low-resistance state of said semiconductor-based switching elements to allow a current flow in the low-voltage circuit;
a current sensor unit for ascertaining a current level of the low-voltage circuit; and
a control unit connected to said current sensor unit, to said mechanical isolating contact unit and to said electronic interruption unit, for initiating avoidance of a current flow in the low-voltage circuit in an event of exceeding at least one of current or current-time limit values.

25. The circuit breaker device according to claim 24, wherein:
said grid-side connections include a grid-side neutral conductor connection and a grid-side phase conductor connection; and
said load-side connections include a load-side neutral conductor connection and a load-side phase conductor connection.

26. The circuit breaker device according to claim 25, wherein:
said load-side neutral conductor connection and said load-side phase conductor connection are connected to said mechanical isolating contact unit; and
said load-side connections are galvanically isolated from other live units of the circuit breaker device and said grid-side connections, upon said contacts of said mechanical isolating contact unit being opened.

27. The circuit breaker device according to claim 25, wherein said electronic interruption unit is a single-pole electronic interruption unit being connected on one side to said grid-side phase conductor connection.

28. The circuit breaker device according to claim 24, which further comprises a power supply unit connected or configured to be connected to said grid-side connections, said power supply unit being connected to said control unit for supplying power.

29. The circuit breaker device according to claim 24, wherein said mechanical isolating contact unit has a handle for manually opening and closing said contacts, and said handle indicates a position of said contacts.

30. The circuit breaker device according to claim 29, wherein said mechanical isolating contact unit is configured to permit closing of said contacts using said handle only upon an enable signal from said control unit being present.

31. The circuit breaker device according to claim 24, wherein said mechanical isolating contact unit is configured to permit said contacts to be opened, but not closed, by said control unit.

32. The circuit breaker device according to claim 24, wherein said mechanical isolating contact unit is configured to make position information about the closed or open state of said contacts available, and the position information is acquired by said control unit.

33. The circuit breaker device according to claim 24, which further comprises a voltage sensor unit for ascertaining a voltage level across connections of said electronic interruption unit of a current path.

34. The circuit breaker device according to claim 25, which further comprises:
a first voltage sensor unit for ascertaining a voltage level across connections of said electronic interruption unit of a current path; and
a second voltage sensor unit for ascertaining a voltage level at said grid-side connections, between said grid-side neutral conductor connection and said grid-side phase conductor connection.

35. The circuit breaker device according to claim 24, which further comprises a display unit connected to said control unit for displaying a low-resistance or a high-resistance state of said electronic interruption unit.

36. The circuit breaker device according to claim 24, which further comprises a wired or wireless communication unit connected to said control unit.

37. The circuit breaker device according to claim 24, which further comprises a temperature sensor unit for ascertaining a temperature of said electronic interruption unit.

38. The circuit breaker device according to claim 24, which further comprises a differential current sensor connected to said control unit for ascertaining a differential current in conductors of the low-voltage circuit.

39. The circuit breaker device according to claim 25, wherein said current sensor unit is provided on a current path side between said grid-side phase conductor connection and said load-side phase conductor connection.

40. The circuit breaker device according to claim 24, which further comprises:
an electronic first part and a mechanical second part of the circuit breaker device;
said electronic first part having one or two circuit boards on which said control unit, a second voltage sensor unit, said current sensor unit, a power supply unit, said electronic interruption unit, a temperature sensor unit and at least one of a first voltage sensor unit or a measurement impedance are provided.

41. The circuit breaker device according to claim 40, wherein:
said grid-side connections include a grid-side neutral conductor connection and a grid-side phase conductor connection;
said load-side connections include a load-side neutral conductor connection and a load-side phase conductor connection; and
said electronic first part has only three connections of the low-voltage circuit, said three connections being:
a first connection for said grid-side phase conductor connection,
a second connection for a grid-side phase conductor connection point of said mechanical isolating contact unit, and
a third connection for a connection to said grid-side neutral conductor connection.

42. The circuit breaker device according to claim 41, wherein said first and second connections have a higher current carrying capacity than said third connection.

43. The circuit breaker device according to claim 41, wherein said connection to said third connection has at least one of a fuse or a switch.

44. The circuit breaker device according to claim 24, which further comprises further grid-side and load-side phase conductor connections, and a series connection of said electronic interruption unit, said current sensor unit and a contact of said mechanical isolating contact unit between each of said further grid-side and load-side phase conductor connections, for a low-voltage circuit being a three-phase AC circuit.

45. The circuit breaker device according to claim 24, wherein upon said contacts of said mechanical isolating contact unit being closed and said interruption unit being in a low-resistance state:
in an event of an ascertained current exceeding a first current value for a first time limit, said electronic interruption unit changes to the high-resistance state and said mechanical isolating contact unit remains closed;
in an event of an ascertained current exceeding a second current value for a second time limit, said electronic interruption unit changes to the high-resistance state and said mechanical isolating contact unit is opened; and
in an event of an ascertained current exceeding a third current value, said electronic interruption unit changes to the high-resistance state and said mechanical isolating contact unit is opened.

46. The circuit breaker device according to claim 24, wherein said control unit has a microcontroller.
